(19) United States
(12) Patent Application Publication
(10) Pub. No.: US 2025/0338220 A1
(43) Pub. Date: Oct. 30, 2025

(54) DYNAMIC BATTERY-LIFE EXTENSION FOR A BATTERY-POWERED DEVICE

(71) Applicant: ITRON, INC., Liberty Lake, WA (US)

(72) Inventors: Mark K. CORNWALL, Spokane, WA (US); James Lee KANN, Mica, WA (US)

(21) Appl. No.: 18/645,230

(22) Filed: Apr. 24, 2024

(51) Int. Cl. H04W 52/02

(52) U.S. Cl. CPC H04W 52/0245; H04W 52/0216; H04W 52/0219

(57) ABSTRACT

Various embodiments disclose a method comprising, determining, by a computing device, that an operating condition of a battery-powered device has been met; determining, by the computing device and based on the operating condition and a network priority for the battery-powered device, an operating parameter of the battery-powered device to be changed; and causing, by the computing device, the operating parameter to be changed from a first value to a second value.

### BACKGROUND

### Field of the Various Embodiments

The various embodiments relate generally to communications networks, and more specifically, to dynamic battery-life extension for a battery-powered device in such networks.

### Description of the Related Art

Many networks, such as low-power wide-area networks (LPWANs) and some cellular networks, include large numbers of remote, battery-powered devices. For example, networks that control and/or monitor large infrastructure systems (e.g., power, water, traffic control, and the like) can include many thousands of devices (e.g., valves, metering devices, controllers, and the like). Generally, in such networks each device corresponds to a node of the network. These types of networks generally include parent nodes communicatively coupled to one or more child nodes, where the child nodes rely on the parent node for connection to the greater network. Due to certain logistical constraints, such as being disposed in remote or difficult-to-access locations, the transmitters for these communication nodes frequently depend on battery power or are required to have battery back-up.

### BRIEF DESCRIPTION OF THE DRAWINGS

So that the manner in which the features of the various embodiments can be understood in detail, a description of the inventive concepts may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual diagram of the operation of a node device in a communications network, according to various embodiments.

FIG. 2 is a more detailed conceptual diagram of the operation of the node device power management application of FIG. 1, according to various embodiments.

FIG. 3 is a conceptual diagram of a node device, according to various embodiments.

FIG. 4 is a flow diagram of method steps for extending the operational lifespan of a battery for a node device in a communications network, according to various embodiments.

FIG. 5 illustrates a network system configured to implement one or more aspects of the various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

Many communications networks link the control and/or monitoring of large numbers of remote, battery-powered devices, such as power meters, water meters, traffic controllers, and the like. For battery-powered devices that operate in varying conditions and environments, achieving a battery end of life that coincides with the targeted end of life of the device may be problematic. For example, identical battery-powered devices may operate under very different workloads and/or environmental conditions that affect battery lifetime. Consequently, two identical devices that have different workloads and operate under different temperatures can have significantly different battery lifetimes. Thus, accurately predicting the operational lifespan of a specific battery-powered device may be very difficult, resulting in the battery life of a device potentially being expended prior to the operational lifespan of the device. This requires replacement of the battery in the field or premature replacement of the device, two outcomes that are highly undesirable.

To avoid such situations, techniques are disclosed herein that enable the operational lifespan of a battery in a battery-powered device to be extended. Specifically, according to various embodiments, the operation of a battery-powered device in a network is automatically modified based on the state of the battery and on the priority of the battery-powered device in the network. When a certain operating condition of the battery-powered device is met (such as a specified time interval elapsing or a current state of a battery reaching a predetermined value), the current value of one or more communication parameters of the battery-powered device is changed, where the one or more communication parameters are determined based on the priority of the battery-powered device in the network.

For a battery-powered device that has a low priority in the network, most or all operating or communication parameters may be eligible to be modified to extend battery life, even when communications frequency and/or latency with the battery-powered device are adversely affected. Examples of a battery-powered device that may have a low priority in the network include a device that is not routing messages to and from other devices in the network, transmits data infrequently, and/or transmits low-importance information or redundant information in the network. By contrast, for a battery-powered device that has a high priority in the network, certain operating or communication parameters may be ineligible to be modified to extend battery life, so that performance of the battery-powered device is not significantly compromised. Examples of a battery-powered device that may have a high priority in the network include a device that is routing messages to and from a relatively large number of other devices in the network, transmits important network data, and/or transmits data frequently.

At least one technical advantage of the disclosed techniques is that the disclosed techniques enable the operational lifespan of a battery in a battery-powered device to be extended so that the operational lifespan of the battery more closely matches the operational lifespan of the battery-powered device.

### Battery-Life Extension for Node Device

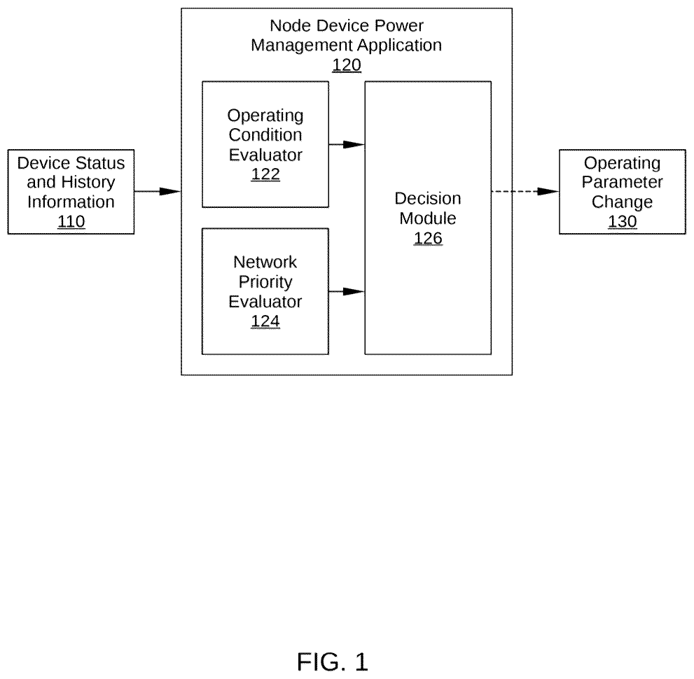

FIG. 1 is a conceptual diagram of the operation of a node device power management application 120 for a node device (not shown) in a communications network, according to various embodiments. The node device can be any battery-powered computing device and/or communication device that communicates with devices within the same communications network, such as a mesh network. In some embodiments, the node device is associated with a utility metering device that is coupled to, or included within, a utility distribution infrastructure. In such embodiments, the metering device monitors consumption of a utility commodity (e.g., water, gas, electricity, etc.). In other embodiments, the node device is associated with a control device (not shown) that is coupled to or included within an infrastructure control network. In such embodiments, the control device associated with the node device controls an element (e.g., a traffic-control light, a streetlight, etc.) of a large infrastructure system.

Node device power management application 120 generates one or more operating parameter changes 130 for the node device based on device status and history information 110. In the embodiment illustrated in FIG. 1, node device power management application 120 includes, without limitation, an operating condition evaluator 122, a network priority evaluator 124, and a decision module 126. In some embodiments, node device power management application 120 resides in the node device and generates the one or more operating parameter changes 130 locally. Alternatively, in some embodiments, node device power management application 120 resides in a network device that is upstream of the node device. For example, in some instances, the node device may be an endpoint node or other low-resource device that has very little processing power. In such instances, a device with greater processing power, such as a computing device on the network edge or at a central office, can run node device power management application 120 and generate the one or more operating parameter changes 130 for the endpoint node device.

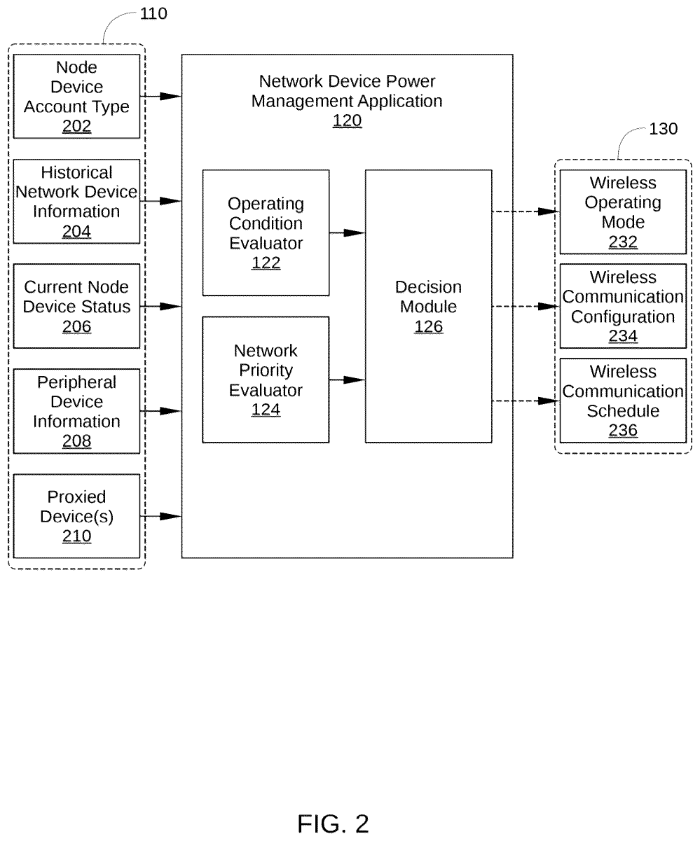

Device status and history information 110 includes information indicating the current status and/or historical behavior of the node device, such as power consumption, battery state, and the like. In some embodiments, device status and history information 110 further includes information indicating the current status and/or historical behavior of a control device, monitoring device, and/or metering device associated with the node device, such as current metering values, historical metering values, etc. Further examples of device status and history information 110 are described below in conjunction with FIG. 2.

Operating parameter changes 130 include changes to the values of one or more operating parameters of the node device that alter the operational lifespan of a battery for powering the node device. In some embodiments, operating parameter changes 130 include values for one or more communication parameters of the node device that are changed to alter the operational lifespan of a battery for powering the node device. Examples of operating parameter changes 130 can include one or more changes to the wireless operating mode of the node device, one or more changes to the wireless configuration of the node device, and/or one or more changes to the wireless communication schedule of the node device. Operating parameter changes 130 are described in greater detail below in conjunction with FIG. 2.

Operating condition evaluator 122 determines one or more operating conditions or operating states of the node device associated with node device power management application 120. Generally, operating condition evaluator 122 determines the one or more operating conditions based on information included in device status and history information 110. Alternatively or additionally, in some embodiments, the one or more operating conditions of the node device determined by operating condition evaluator 122 can be based on battery information, such as a current battery state (e.g., current charge level) or a historical trend of a battery state (e.g., rate of decrease in charge level). Alternatively or additionally, in some embodiments, the one or more operating conditions of the node device determined by operating condition evaluator 122 can be based on a current behavior of a peripheral device associated with the node device.

Network priority evaluator 124 determines the current priority of the node device in the communications network. In some embodiments, network priority evaluator 124 determines the priority of the node device based on various factors associated with the node device. In some embodiments, network priority evaluator 124 determines the priority of the node device based on the type of peripheral device associated with the battery-powered device. In some embodiments, network priority evaluator 124 determines the priority of the node device based on an account type that is associated with the node device. In some embodiments, network priority evaluator 124 determines the priority of the node device based on factors that can change over the operational lifespan of the node device, such as network-related factors (e.g., whether more traffic is routed through the node device).

Decision module 126 determines an operating parameter of the node device associated with node device power management application 120 to be changed and generates operating parameter change 130. In some embodiments, decision module 126 makes the determination based on the operating condition determined by operating condition evaluator 122 and/or on the network priority determined by network priority evaluator 124. In some embodiments, decision module 126 further determines how the operating condition is to be changed.

FIG. 2 is a more detailed conceptual diagram of the operation of node device power management application 120, according to various embodiments. As shown, node device power management application 120 includes operating condition evaluator 122, network priority evaluator 124, and decision module 126.

Operating condition evaluator 122 determines one or more operating conditions of the node device associated with node device power management application 120. Generally, operating condition evaluator 122 determines the one or more operating conditions based on information included in device status and history information 110. For example, in some embodiments, the one or more operating conditions of the node device can be based on historical device information included in device status and history information 110, such as changes over time in RF signal strength of the node device, frequency of transmissions by the node device, historical power consumption of the node device, and the like. In one such embodiment, a particular operating condition is recognized by operating condition evaluator 122 when RF signal strength of the node device drops below (or increases above) a certain threshold value. In another such embodiment, a particular operating condition is recognized by operating condition evaluator 122 when a frequency of transmissions by the node device drops below (or increases above) a certain threshold value. In another such embodiment, a particular operating condition is recognized by operating condition evaluator 122 when a power consumption of the node device matches a certain trend and/or drops below (or increases above) a certain threshold value.

Alternatively or additionally, in some embodiments, the one or more operating conditions of the node device determined by operating condition evaluator 122 can be based on battery information, such as a current battery state (e.g., current charge level) or a historical trend of a battery state (e.g., rate of decrease in charge level). Thus, in such embodiments, a particular operating condition is recognized by operating condition evaluator 122 when the current battery state (or historical trend of a battery state) meets a threshold condition. In one such embodiment, when a charge level of a battery falls below a threshold value, the operational lifespan of the battery is indicated to likely expire before the operational lifespan of the node device, and this operating condition is determined by operating condition evaluator 122. In another such embodiment, when a rate of decrease in charge level of a battery exceeds a threshold value, the operational lifespan of the battery is indicated to likely expire before the operational lifespan of the node device, and this operating condition is determined by operating condition evaluator 122. In some embodiments, the above-described threshold values can be fixed values. Alternatively, in some embodiments, the above-described threshold values can be variable values that change over the expected operational lifespan of the node device. Thus, in such embodiments, operating condition evaluator 122 can determine a certain operating condition based on different threshold values that vary over the operational lifespan of the node device.

Alternatively or additionally, in some embodiments, the one or more operating conditions of the node device determined by operating condition evaluator 122 can be based on a current behavior of a peripheral device associated with the node device. For example, in some embodiments, a particular operating condition is recognized by operating condition evaluator 122 when no changes in a reported output of the peripheral device are reported for a certain time interval. In such embodiments, the lack of change of information being reported by the peripheral device (such as a water flow rate for a pump that is not used for several winter months) can indicate that there is no benefit in the node device reporting such a lack of change at a high frequency, and this operating condition can be determined by operating condition evaluator 122.

In the embodiments described above, operating condition evaluator 122 determines an operating condition of a node device based on discrete operating values or states of the node device, the battery for the node device, and/or a peripheral device associated with the node device. In other embodiments, operating condition evaluator 122 algorithmically determines an operating condition of a node device. Thus, in such embodiments, operating condition evaluator 122 determines an operating condition based on a calculation that is based on one or more discrete operating values or states of the node device, one or more discrete operating values or states of the battery for the node device, and/or one or more discrete operating values or states of the peripheral device associated with the node device. For example, when network traffic handled by the node device increases over the operational lifespan of the node device, one or more threshold values associated with the battery can be modified to reflect the increased power consumed by the node device.

Network priority evaluator 124 determines the current priority of the node device in the communications network. In some embodiments, network priority evaluator 124 determines the priority of the node device based on various factors associated with the node device.

In some embodiments, network priority evaluator 124 determines the priority of the node device based on recent operating behavior of the node device. For example, in such embodiments, higher levels of network traffic being routed through the node device (or other behaviors) can indicate that the node device has a higher priority in the communications network than other node devices. In some embodiments, network priority evaluator 124 determines the priority of the node device based on the number of network devices that the node device is routing messages to and from, sometimes referred to as “child devices” or “proxied devices.” For example, in such embodiments, a node device that is routing messages to and from few or no proxied devices can be considered a lower priority node device in the communications network, since increases in communications latency do not impact a large number of other node devices. Conversely, a node device that is routing messages to and from a large number of proxied devices can be considered a higher priority node device in the communications network, since increases in communications latency impact a large number of other node devices.

In some embodiments, network priority evaluator 124 determines the priority of the node device based on the type of peripheral device associated with the battery-powered device. For example, in some embodiments, the node device can be associated with a gas-, water-, or power-metering device, a control valve, an emergency shut-off valve, a gas-leak sensor, and the like. In such embodiments, a node device that is not associated with any peripheral devices can be considered to be a lower priority in the communications network than a node device that is associated with a peripheral device. Further, in such embodiments, a node device associated with certain peripheral devices can be considered to be a higher priority in the communications network than a node device associated with certain other peripheral devices. For example, in some embodiments, a node device that is associated with a metering device for a single residence can be considered to be a lower priority node device than a node device that is associated with a metering device for a larger consumer, such as a commercial building. In another example, in some embodiments, a node device that is associated with a metering device can be considered to be a lower priority node device than a node device that is associated with one or more a safety-related devices, such as a disconnect valve to shut off gas or water, a leak sensor to detect gas leaks, etc. Alternatively or additionally, in some embodiments, a node device that is associated with a metering device can be considered to be a lower priority node device than a node device that is associated with a control device, such as a shut-off valve, a flow-control valve, and the like.

In some embodiments, network priority evaluator 124 determines the priority of the node device based on an account type that is associated with the node device. For example, in some embodiments, a peripheral device associated with the node device (e.g., a gas-, water-, or power-metering device) can be linked to a certain type of account. In such embodiments, a node device that is associated in this way with a residential account can be considered to be a lower priority node device than a node device that is associated with a commercial account. In another example, in some embodiments, a node device that is associated in this way with an infrastructure account can be considered to be a higher priority node device than a node device that is associated with a commercial account or with a residential account.

In some embodiments, network priority evaluator 124 determines the priority of the node device based on factors that can change over the operational lifespan of the node device, such as network-related factors (e.g., whether a relatively higher amount of traffic is routed through the node device) and/or peripheral device-related factors (e.g., a state of the peripheral device, such as whether the peripheral device associated with the node device is turned off or inactive). Alternatively, in some embodiments, a network priority for a particular node device is fixed within the communications network. Thus, in such embodiments, variable conditions within the communications network and/or the current state of the node device do not alter the network priority for that particular node device. As a result, network priority evaluator 124 determines the network priority for the particular node device based on the fixed priority.

Decision module 126 determines an operating parameter of the node device associated with node device power management application 120 to be changed and generates operating parameter change 130. In some embodiments, decision module 126 makes the determination based on the operating condition determined by operating condition evaluator 122 and/or on the network priority determined by network priority evaluator 124. In some embodiments, decision module 126 further determines how the operating condition is to be changed. For example, in such embodiments, decision module 126 generates operating parameter change 130 by determining that at least one parameter that affects the determined operating condition of the node device is to be changed from a first (previous) value to a second (new) value. In this way, operation of the node device is modified and the operational lifespan of the battery of the node device is changed. Thus, in operation, decision module 126 generates operating parameter change 130 to extend the operational lifespan of the battery for the node device. Alternatively, in some embodiments, decision module 126 generates operating parameter change 130 to reduce the operational lifespan of the battery for the node device, for example when the determination is made that the operational lifespan of the battery, under current operating conditions, may significantly exceed the operational lifespan of the node device. In such embodiments, performance of the node device can be increased, due to the battery of the node device having a predicted surplus charge.

In the embodiment shown in FIG. 2, device status and history information 110 includes, without limitation, a node device account type 202, historical node device information 204, a current node device status 206, peripheral device information 208, and one or more proxied devices 210. In the embodiment shown in FIG. 2, operating parameter change 130 includes, without limitation, a wireless operating mode 232, a wireless communication configuration 234, and a wireless communication schedule 236. As shown, device status and history information 110 includes inputs to node device power management application 120 and operating parameter change 130 includes outputs from node device power management application 120.

Node device account type 202 indicates a particular account type for the node device that is associated with node device power management application 120. In embodiments in which the node device is included in a network associated with a utility distribution infrastructure, node device account type 202 can include a commercial account or a residential account. Alternatively or additionally, node device account type 202 can include other account types, such as an account type that is inactive during a specified period, an account type that is associated with renewable energy generation, an account type that is associated with one or more special services (such as leak detection, remote valve shut-off, etc.), and the like.

Historical node device information 204 can include historical device information and/or battery information, such as a record of previous RF signal strength of the node device when transmitting and/or receiving signals, a record of previous frequency of transmissions by the node device and/or other network history, a record of previous power consumption of the node device, a record of available charge of the battery for the node device, a record of the ability for the battery to recharge (when the battery for the node device is a rechargeable battery), and the like.

Current node device status 206 includes information indicating the current status of the node device and/or the battery for the node device. In some embodiments, current node device status 206 can include RF signal strength of the node device when transmitting and/or receiving signals, the current frequency of transmissions by the node device and/or other network metrics, the current power consumption of the node device, the current available charge of the battery for the node device, the current ability for the battery to recharge, and the like.

Peripheral device information 208 includes information indicating the type and number of peripheral devices that are associated with the node device. Such peripheral devices can include one or more sensors (e.g., leak detectors, weather-related sensors, and the like), metering devices, controllers, shut-off valves, control valves, and the like. The one or more proxied devices 210 includes information indicating the number of proxied node devices that are downstream of the node device.

Wireless operating mode 232 can include values for one or more parameters that affect the wireless mode of the node device. For example, in some embodiments, a node device can operate in one of multiple operating modes, such as extended discontinuous reception (eDRX), in which the node device connects to the network every few minutes, and power-saving mode (PSM), in which the node device connects to the network a few times per day. Thus, when operating in PSM, the node device consumes significantly less power than when operating in eDRX. Consequently, in some embodiments, to extend the operational lifespan of the battery for the node device, decision module 126 can cause the wireless operating mode of the node device to be changed from eDRX to PSM. In other embodiments, additional wireless modes may be available for a particular node device in lieu of or addition to eDRX and PSM.

Wireless communication configuration 234 can include values for one or more parameters that affect the wireless mode of the node device. For example, in some embodiments, one such parameter can include a time period after which a tracking area update (TAU) is performed by the node device, which is sometimes referred to as a PSM TAU value. In such embodiments, increasing this time period, for example from 50 hours to 60 hours, increases communications latency in the communications network but reduces the rate at which power is consumed by the node device. In some embodiments, another such parameter can include a time period during which the node device is available in the network when in PSM, which is sometimes referred to as a “PSM active time.” In such embodiments, decreasing this time period, for example from 14 second to 12 seconds, decreases the amount of time the device is available after connecting to the communications network but reduces the rate at which power is consumed by the node device. In some embodiments, another such parameter can include the paging time window (PTW), which is the period of time that the node device looks for downlink pages from the network so that it can receive incoming traffic. In such embodiments, decreasing this time period, for example from 3.84 second to 1.28 seconds, decreases performance of the communications network but reduces the rate at which power is consumed by the node device. In some embodiments, such parameters can include one or more other connections parameters, such as a number of transmission retries to be performed by the node device when encountering errors.

Wireless communication schedule 236 can include values for one or more parameters that affect the wireless operating schedule of the node device. For example, in some embodiments, one such parameter can include a data push schedule. In such embodiments, increasing this time period, for example from 6 hours to 12 hours, decreases the frequency at which data is pushed from the node device and reduces the rate at which power is consumed by the node device. In some embodiments, another such parameter can include a number of new device beacon transmissions that are skipped. In some communications networks, such beacon transmissions are periodically transmitted from a node device so that new node devices can join the communications network as a proxied node device. In many instances, some portion of such beacon transmissions can be skipped without risking the loss of proxied node devices. In such embodiments, skipping every nth new device beacon transmission reduces power consumption of the node device with low impact to the functioning of the communications network. In some embodiments, additional scheduling parameters may be available for a particular node device in lieu of or addition to a data push schedule and a number of new device beacon transmissions that are skipped.

### Node Device

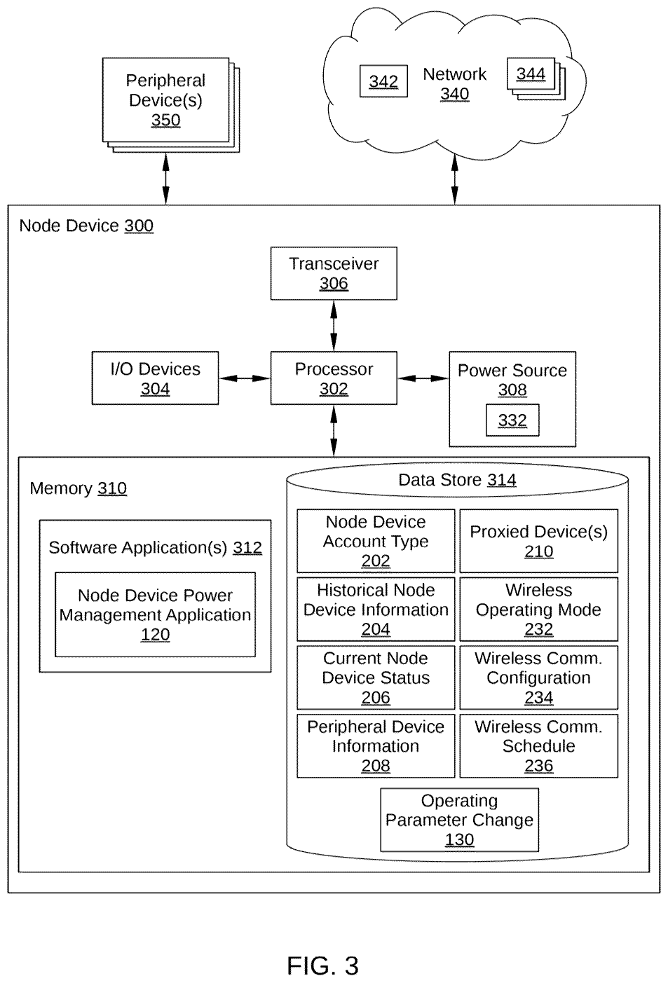

FIG. 3 is a conceptual diagram of a node device 300, according to various embodiments. Node device 300 can be any communication device that communicates with devices in a network. In one example, node device 300 is a utility metering device that is coupled to, or included within, a utility distribution infrastructure in which node device 300 monitors consumption of a utility commodity (e.g., water, gas, electricity, etc.). In some embodiments, node device 300 is associated with node device power management application 120 of FIGS. 1 and 2. As shown, node device 300 includes, without limitation, processor 302, input/output (I/O) devices 304, transceiver 306, power source 308, and memory 310, coupled together.

Also shown in FIG. 3 is a communications network 340 that is communicatively coupled to node device 300 and one or more peripheral devices 350 that are associated with node device 300. In the embodiment illustrated in FIG. 3, communications network 340 includes a proxy device 342 of node device 300 and multiple proxied devices 344 of node device 300.

Processor 302 coordinates operations of node device 300. In various embodiments, processor 302 includes any hardware configured to process data and execute software applications. The processor 302 can be any technically feasible processing device configured to process data and execute program instructions. For example, processor 302 can include one or more central processing units (CPUs), DSPs, graphics processing units (GPUs), application-specific integrated circuits (ASICs), field-programmable gate arrays (FPGAs), microprocessors, microcontrollers, other types of processing units, and/or a combination of different processing units. Processor 302 can include a real-time clock (RTC) (not shown) according to which processor 302 maintains an estimate of the current time. The estimate of the current time can be expressed in Universal Coordinated Time (UTC), although any other standard of time measurement can also be used.

I/O devices 304 include devices configured to receive input, devices configured to provide output, and devices configured to both receive input and provide output. As described above, in some examples, node device 300 is a utility metering device that is coupled to, or included within, a utility distribution infrastructure. In this example, I/O devices 304 can further include one or more data acquisition devices that are used by node device 300 to monitor consumption of a utility commodity (e.g., water, gas, electricity, etc.). For example, I/O devices 304 can further include one or more of an electricity meter, a gas meter, a water meter, or some other type of sensor used to monitor consumption of a utility commodity.

Transceiver 306 is configured to transmit messages to and/or receive messages from other devices in communications network 340. In some embodiments, the other devices include proxied devices 344 of node device 300 and/or proxy device 342 of node device 300. Transceiver 306 can be implemented as any suitable transmission and/or reception device. In some examples, transceiver 306 can operate in a first communication mode in which transceiver 306 communicates with one or more devices in a first type of network and can operate in a second communication mode in which transceiver 306 communicates with one or more devices in a second type of network. For example, while in the first communication mode, transceiver 306 transmits messages to and/or receives messages from devices in a first type of network (e.g., Cat-M1 network) via a first type of access point. As another example, while in the second communication mode, transceiver 306 transmits messages to and/or receives messages from devices in a second type of network (e.g., NB-IoT network) via a second type of access point. In operation, transceiver 306 can transition between communication modes. In some examples, transceiver 306 can operate in more than two communication modes and/or communicate with devices in more than two different types of networks. Operation of transceiver 306 can be modified by one or more operating parameter changes 130, which are described above in conjunction with FIGS. 1 and 2.

Power source 308 provides power to one or more of the components included in node device 300. For example, in some embodiments, power source 308 powers one or more of processor 302, I/O devices 304, transceiver 306, and memory 310. As shown, power source 308 includes a battery 332 that is used to provide power and/or back-up power to one or more components of node device 300. In some embodiments, battery 332 is a rechargeable battery. In such embodiments, the recharging lifespan of battery 332 is selected to correspond closely to the operational lifespan of node device 300. In other embodiments, battery 332 is a non-rechargeable battery that is the sole power source for node device 300. In such embodiments, the operational lifespan of battery 332 is selected to correspond closely to the operational lifespan of node device 300. In some embodiments, power source 308 also includes a power connection to a permanent power supply. In such embodiments, battery 332 is generally employed as a back-up power source for node device 300.

Memory 310 includes one or more software applications 312 and a data store 314, communicatively coupled together. In the embodiment shown in FIG. 3, the one or more software applications 312 include node device power management application 120. In some embodiments, data store 314 stores, among other things, node device account type 202, historical node device information 204, current node device status 206, peripheral device information 208, and/or information associated with one or more proxied devices 210. Alternatively or additionally, in some embodiments, data store 314 stores, among other things, wireless operating mode 232, wireless communication configuration 234, wireless communication schedule 236, and/or other information associated with operating parameter change 130.

Peripheral devices 350 can include one or more devices controlled by, monitored by, or otherwise associated with device node 300. In some embodiments, such peripheral devices can include one or more sensors (e.g., leak detectors, weather-related sensors, and the like), metering devices, controllers, shut-off valves, control valves, and the like.

### Process for Dynamic Battery-Life Extension for Node Device

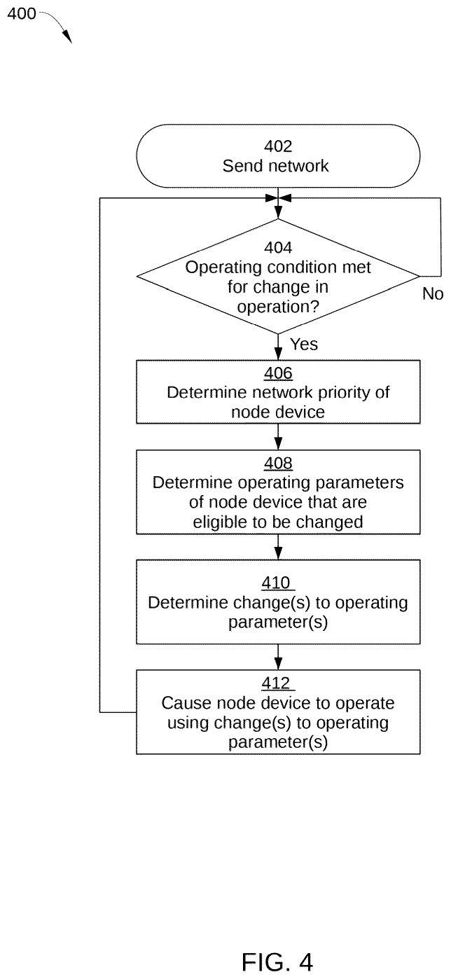

FIG. 4 is a flow diagram of method steps for extending the operational lifespan of a battery for a node device in a communications network, according to various embodiments. Although the method steps are described with respect to the systems of FIGS. 1-3, persons skilled in the art will understand that any system configured to perform the method steps, in any order, falls within the scope of the various embodiments.

As shown, a method 400 begins at step 402, where a computing device begins a process for extending the operational lifespan of a battery for a node device in a communications network, such as node device 300 in communications network 340. In some embodiments, the computing device that performs method 400 is included in node device 300. In other embodiments, the computing device that performs method 400 is a separate network device from node device 300, such as a computing device on the network edge.

In step 404, the computing device determines, via operating condition evaluator 122, whether an operating condition has been met indicating the operational lifespan of battery 332 is estimated to be different than the operational lifespan of node device 300. When such an operating condition has been met, a change in operation of node device 300 can be modified so that the operational lifespan of battery 332 can more closely match the operational lifespan of node device 300.

In some embodiments, the operating condition can be based on current battery information, such as a current battery life value associated with battery 332. In such embodiments, when battery 332 is determined to have a remaining battery life value that is significantly different than a target battery life value, the operating condition has been met. For example, in one such embodiment, when 75% of the operational lifespan of node device 300 is remaining, the target battery life value for battery 332 is 75%. Thus, in such an embodiment, when 75% of the operational lifespan of node device 300 is remaining, operating condition evaluator 122 determines whether the current estimated battery life for battery 332 varies significantly (e.g., greater than 1%) from the target battery life value of 75%. If yes, method 400 proceeds to step 406; if no, method 400 returns to step 404. In such embodiments, the remaining battery life value may be checked at multiple intervals throughout the operational life of node device 300, for example when 75% of the operational lifespan of node device 300 is remaining, when 50% of the operational lifespan of node device 300 is remaining, and so on. In some embodiments, such intervals are time-based intervals, and in other embodiments, such intervals are battery-level-based intervals. Conversely, in some embodiments, when the current estimated battery life for battery 332 reaches one or more particular values (e.g., 75%, 50%, 25%), operating condition evaluator 122 determines whether the current estimated battery life for battery 332 varies significantly from estimated operational lifespan of node device 300. If yes, method 400 proceeds to step 406; if no, method 400 returns to step 404.

In some embodiments, the operating condition can be based on one or more characteristics of the operation of node device 300, such as a current behavior of node device 300 and/or a trend in the behavior of node device 300. For example, in some embodiments, the operating condition has been met when the current RF signal strength of node device 300 falls below a specified threshold, when node device 300 has been operating for a specified time interval, when node device 300 consumes power above a threshold value (and/or below a different threshold), and/or the like. Alternatively or additionally, in some embodiments, the operating condition has been met when historical values of RF signal strength match a specified trend, when historical values of power consumption match a specified trend, when node device 300 has transmitted network traffic at a rate that exceeds a specified threshold (and/or falls below a different threshold), and/or the like. In some embodiments, the operating condition can be a fixed value associated with such a characteristic of the operation of node device 300, and in other embodiments, meeting the operating condition can be based on an algorithmic combination of multiple values associated with such characteristics of the operation of node device 300. In such embodiments, method 400 proceeds to step 406 when one or more such operating conditions have been met and otherwise returns to step 404.

In some embodiments, the operating condition can be based on one or more behaviors or characteristics of a peripheral device 350 associated with node device 300. In some embodiments, the operating condition has been met when such a peripheral device 350 has no changes in reported output for a specified time interval. For example, in an embodiment, the peripheral device 350 may be water-supply valve that remains closed for a period of several months at a time. Thus, in this embodiment, when the supply valve has not been opened for a specified time interval, the operating condition has been met and method 400 proceeds to step 406. In another embodiment, the peripheral device 350 may have the ability to report an inactive or active status. Thus, in this embodiment, when the status of the peripheral device is reported to change, the operating condition has been met and method 400 proceeds to step 406. In some embodiments, the operating condition can be a fixed value associated with such a characteristic of the peripheral device, and in other embodiments, meeting the operating condition can be based on an algorithmic combination of multiple values associated with such characteristics of the peripheral device. In such embodiments, method 400 proceeds to step 406 when one or more such operating conditions have been met and otherwise returns to step 404.

In step 406, network priority evaluator 124 determines the network priority of node device 300. In some embodiments, the network priority of node device 300 is a fixed value. Alternatively, in some embodiments, the network priority of node device 300 is determined periodically by the computing device and/or node device 300. In such embodiments, the current network priority of node device 300 can be stored and looked up in step 406. For example, the current network priority of node device 300 can be stored in data store 314. Alternatively, in some embodiments, the computing device and/or node device 300 calculates or otherwise determines the network priority of node device 300 in step 406.

In some embodiments, network priority evaluator 124 determines the network priority of node device 300 based on one or more of a recent operating behavior of node device 300, the number of network proxied devices of node device 300, the type of account associated with node device 300, the type of peripheral device 350 that is associated with node device 300, and the like. For example, in some embodiments, a node device 300 having a larger number of proxied devices generally has a higher network priority than a node device 300 have fewer or no proxied devices. In another example, in some embodiments, a node device 300 that is associated with a more important peripheral device 350 generally has a higher network priority than a node device 300 associated with a less important peripheral device 350 or no peripheral devices 350. In another example, in some embodiments, a node device 300 that handles a greater quantity of network traffic generally has a higher network priority than a node device 300 that handles a lower quantity of network traffic.

In step 408, decision module 126 determines one or more operating parameters of node device 300 that are eligible to be changed. Examples of operating parameters that can be changed include, without limitation, one or more parameters that affect the wireless mode of node device 300, one or more parameters that affect the wireless communication configuration of node device 300, and/or one or more parameters that affect the wireless communication schedule of the node device.

Generally, decision module 126 determines the one or more operating parameters that are eligible to be changed based on the network priority of device node 300. In some embodiments, certain operating parameters of node device 300 are ineligible for being changed when device node 300 has a sufficiently high network priority. For example, in an instance in which node device 300 has multiple proxied devices, wireless operating mode 232 may not be eligible to be changed from eDRX to PSM due to the large quantity of network traffic that is impacted when node device 300 operates in PSM. In another example, in an instance in which node device 300 is associated with an important or safety-related peripheral device 350, such as a gas leak sensor, wireless operating mode 232 may not be eligible to be changed from eDRX to PSM due to the network latency associated with node device 300 being offline for long periods of time.

In some embodiments, decision module 126 determines the one or more operating parameters eligible to be changed further based on the particular operating condition that is determined to be met in step 404. Thus, in such embodiments, certain operating conditions may indicate that one or more particular operating parameters are to be changed or are ineligible to be changed. For example, in an instance in which node device 300 is determined to have an RF signal strength that is below a specified threshold, the number of new device beacon transmissions that are skipped may be ineligible to be changed from the value 0, thereby preventing the loss of new proxied devices in communications network 340.

In step 410, decision module 126 generates operating parameter change 130 by determining one or more eligible operating parameters to be changed and new values for the one or more operating parameters to be changed. In some embodiments, to determine whether a certain operating parameter is to be changed, decision module 126 determines or looks up a change in power consumption of node device 300 associated with each operating parameter that is eligible to be changed. In such embodiments, for each operating parameter that is eligible to be changed, decision module 126 determines or looks up a change-in-power-consumption value associated with changing the operating parameter from a current value to one or more new values. Thus, in such embodiments, decision module 126 may determine or look up multiple change-in-power-consumption values for each eligible operating parameter. For example, in an instance in which node device 300 currently operates with a data push schedule of 6 hours, decision module 126 determines or looks up a different change-in-power-consumption value for each data push schedule that is available for node device 300 (e.g., 8 hours, 12 hours, and 24 hours). In such embodiments, decision module 126 can then select a new value for one or more operating parameters of node device 300 based on the various changes in power consumption associated with each possible new value for each operating parameter. In this way, decision module 126 can select an operating parameter and/or a combination of operating parameters to be changed that result in node device 300 consuming power at a targeted rate, where the targeted rate modifies the operational life of battery 332 to match the estimated operational lifespan of node device 300 more closely.

In some embodiments, values of the one or more operating parameter to be changed can be selected to extend battery life, for example when operating condition evaluator 122 determines that the operational lifespan of battery 332 is indicated to likely expire before the operational lifespan of node device 300. Alternatively or additionally, in some embodiments, values of the one or more operating parameter to be changed can be selected to reduce battery life, for example when operating condition evaluator 122 determines that the operational lifespan of battery 332 is indicated to likely extend beyond the operational lifespan of node device 300.

In step 412, the computing device causes node device 300 to operate using the one or more changed operating parameters while set to the new values determined in step 410. As a result, power consumption of node device 300 is modified, and the operational life of battery 332 more closely matches the estimated operational lifespan of node device 300. Method 400 then returns to step 404. In embodiments in which the computing device that performs method 400 is a separate network device from node device 300, the computing device causes node device 300 to operate using the one or more changed operating parameters by transmitting operating parameter changes 130 to node device 300.

### System Overview

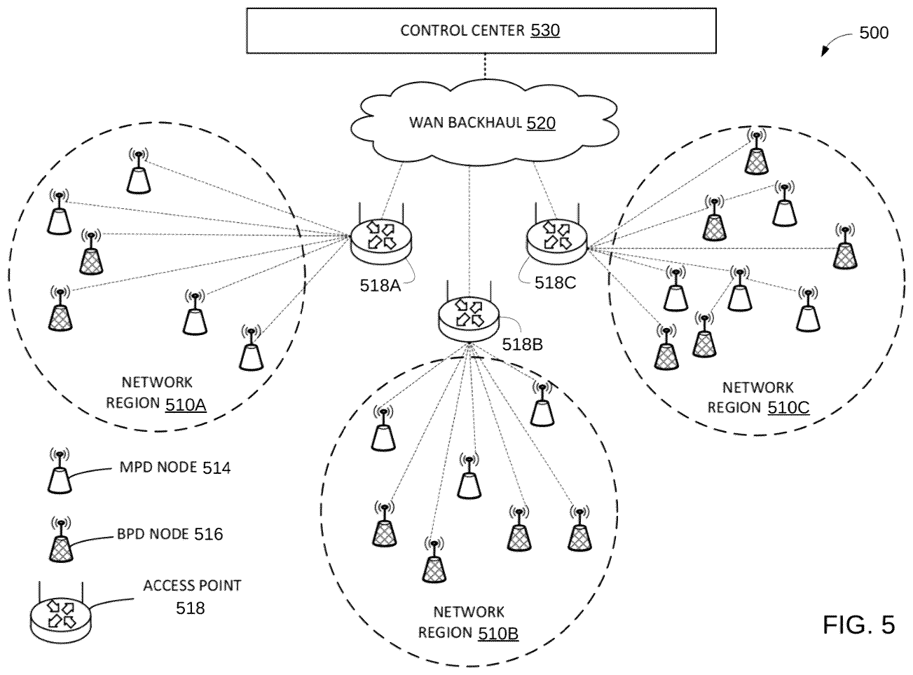

FIG. 5 illustrates a network system 500 configured to implement one or more aspects of the various embodiments. In some embodiments, network system 500 is consistent with communications network 340 in FIG. 3. Network system 500 is, for example, a constrained network such as a Cat-M1 network or an NB-IoT network. Network system 500 includes one or more network regions 510, a wide area network (WAN) backhaul 520, and a control center 530 that coordinates operation of node devices in the one or more network regions 510. Such node devices can be consistent with node device 300 in FIG. 3.

In the illustrated example of FIG. 5, the one or more network regions 510 include a first network region 510A, a second network region 510B, and a third network region 510C. Each of network regions 510A, 510B, and 510C includes various network devices including one or more mains-powered device (MPD) nodes 514 and/or one or more battery-powered device (BPD) nodes 516. Any of the one or more MPD nodes 514 or the BPD nodes 516 can be used to implement the techniques discussed above with respect to FIGS. 1-4. In various embodiments, node device 300 is implemented as node 514 or 516. MPD nodes 514 draw power from an external power source, such as mains-power or a power grid. MPD nodes 514 typically operate on a continuous basis without powering down for extended periods of time. BPD nodes 516 draw power from an internal power source, such as a battery and/or from a non-mains power source such as a solar power source. BPD nodes 516 typically operate intermittently and power down, or go into very low power mode, for extended periods of time in order to conserve battery power.

Network system 500 further includes one or more access points 518 that connect respective MPD nodes 514 and/or BPD nodes 516 in the one or more network regions 510 to control center 530 via WAN backhaul 520. In the illustrated example of FIG. 5, the one or more access points 518 include a first access point 518A, a second access point 518B, and a third access point 518C. First access point 518A connects the one or more MPD nodes 514 and/or BPD nodes 516 in first network region 510A to control center 530 via WAN backhaul 520. Similarly, second access point 518B connects the one or more MPD nodes 514 and/or BPD nodes 516 in second network region 510B to control center 530 via WAN backhaul 520 and third access point 518C connects the one or more MPD nodes 514 and/or BPD nodes 516 in third network region 510C to control center 530 via WAN backhaul 520. In various embodiments, access point is implemented as one or more access points 518. Furthermore, in various embodiments, one or more of access points 518 can be implemented as one or more of a sector antenna located at a cellular base station, a wireless access point, a router, a gateway, a transceiver, or some other type of network device that enables nodes to connect to devices in network system 500. In some embodiments, access points 518 are implemented as nodes, such as MPD nodes or BPD nodes.

In one example, first access point 518A, second access point 518B, and third access point 518C are implemented as respective sector antennas located at a cellular base station. In this example, first network region 510A is a first cell sector emanating from first access point 518A, second network region 510B is a second cell sector emanating from second access point 518B, and third network region 510C is a third cell sector emanating from third access point 518C. Furthermore, in this example, network system 500 is a cellular network such as a Cat-M1 network or an NB-IoT network.

In some examples, any of MPD nodes 514, BPD nodes 516, and/or access points 518 are configured to communicate directly with one or more adjacent nodes via bi-directional communication links. The communication links can be wired or wireless links, although in practice, adjacent nodes of a given network region 510 exchange data with one another by transmitting data packets via wireless radio frequency (RF) communications. In some examples, an MPD node 514 and/or a BPD node 516 can connect to an access point 518 via one or more intermediate nodes. For example, as shown with respect to network region 510C, MPD nodes 514 and BPD nodes 516 can connect to access point 518C via intermediate MPD nodes 514 and BPD nodes 516. In some examples, a node 514, 516 connects to another node 514, 516 using a first communication protocol and connects to an access point 518 using a second communication protocol.

A node can transmit, via a given access point 518 to which the node is connected, data packets and/or messages that contain data packets across WAN backhaul 520 to control center 530. Similarly, control center 530 can transmit data packets and/or messages that contain data packets across WAN backhaul 520 to a particular node via a given access point 518 to which the particular node is connected.

In some examples, MPD nodes 514 and BPD nodes 516 are implemented as utility metering devices that are coupled to, or included within, a utility distribution infrastructure (not shown) that distributes a resource and/or utility commodity to consumers. In such examples, MPD nodes 514 and BPD nodes 516 gather sensor data related to the distribution of the resource and/or utility commodity, gather sensor data related to the consumption of the resource and/or utility commodity, process the sensor data, and communicate processing results and other information to control center 530 via access points 518.

Control center 530 includes one or more server machines (not shown) configured to operate as sources for, or destinations of, data packets and/or messages that traverse within network system 500. The server machines can query nodes within network system 500 to obtain various data, including raw or processed sensor data, power consumption data, node/network throughput data, status information, and so forth. The server machines can also transmit commands and/or program instructions to any node within network system 500 to cause those nodes to perform various operations. In one embodiment, each server machine is a computing device configured to execute, via a processor, a software application stored in a memory to perform various network management operations.

In sum, techniques are disclosed herein that enable the operational lifespan of a battery in a battery-powered device to be extended. According to various embodiments, the operation of a battery-powered device in a network is automatically modified based on the state of the battery and on the priority of the battery-powered device in the network. When a certain operating condition of the battery-powered device is met, the current value of one or more communication parameters of the battery-powered device is changed.

1. In some embodiments, a method includes: determining, by a computing device, that an operating condition of a battery-powered device has been met; determining, by the computing device and based on the operating condition and a network priority for the battery-powered device, an operating parameter of the battery-powered device to be changed; and causing, by the computing device, the operating parameter to be changed from a first value to a second value.

2. The method of clause 1, wherein the operating condition of the battery-powered device is determined based on one or more of a current state of the battery-powered device, historical information associated with the battery-powered device, a current state of the battery, historical information associated with the battery, a current behavior of a peripheral device associated with the battery-powered device, or a specified time interval.

3. The method of clauses 1 or 2, wherein the historical information includes at least one of a change over time in radio frequency (RF) signal strength of the battery-powered device, a frequency of transmissions by the battery-powered device, a historical power consumption of the battery-powered device, or information indicating historical behavior of the peripheral device associated with the battery-powered device.

4. The method of any of clauses 1-3, wherein the operating condition varies over an operational lifespan of the computing device.

5. The method of any of clauses 1-4, wherein the operating condition is determined for a specified time interval.

6. The method of any of clauses 1-5, further comprising determining, by the computing device, the operating condition of the battery-powered device based on at least one of a discrete operating value or state of the battery-powered device, a discrete operating value or state of the battery, or a discrete operating value or state of a peripheral device associated with the battery-powered device.

7. The method of any of clauses 1-6, further comprising determining, by the computing device, the network priority of the battery-powered device based on at least one of a recent operating behavior of the battery-powered device, a type of peripheral device associated with the battery-powered device, an account type associated with the battery-powered device, a quantity of network traffic routed through the battery-powered device, or a state of the peripheral device.

8. The method of any of clauses 1-7, wherein determining the operating parameter of the battery-powered device to be changed comprises determining one or more operating parameters of the battery-powered device that are eligible to be changed, wherein the one or more operating parameters of the battery-powered device that are eligible to be changed are determined based on at least one of the network priority of the battery-powered device or the operating condition of the battery-powered device.

9. The method of any of clauses 1-8, wherein determining the operating parameter of the battery-powered device to be changed comprises determining one or more communication parameters of the battery-powered device that are eligible to be changed, wherein the one or more communication parameters of the battery-powered device that are eligible to be changed include at least one of an extended discontinuous reception (eDRX) value, a paging window duration, a data push schedule, a wireless operating mode, or a number of new device beacon transmissions that are to be skipped.

10. The method of any of clauses 1-9, further comprising determining, by the computing device, the second value based on a change in power consumption of the battery-powered device associated with the second value.

11. In some embodiments, a network device, includes: one or more processors; and a memory storing executable instructions that, when executed by the one or more processors, cause the one or more processors to perform the steps of: determining that an operating state of a battery-powered device has been met; determining, based on the operating state and a network priority for the battery-powered device, an operating parameter of the battery-powered device to be updated; and causing the operating parameter to be updated from a first value to a second value.

12. The network device of clause 11, wherein causing the operating parameter of the battery-powered device to be updated from the first value to the second value comprises transmitting the second value to the battery-powered device from a computing device separate from the battery-powered device.

13. The network device of clauses 11 or 12, wherein the battery-powered device determines that the operating condition of the battery-powered device has been met and that the operating parameter of the battery-powered device is to be updated.

14. The network device of any of clauses 11-13, further comprising determining an operational lifespan of the battery is less than an operational lifespan of the battery-powered device, wherein the second value corresponds to a lower power consumption by the battery-powered device.

15. The network device of any of clauses 11-14, further comprising determining an operational lifespan of the battery is greater than an operational lifespan of the battery-powered device, wherein the second value corresponds to a higher power consumption by the battery-powered device.

16. In some embodiments, one or more non-transitory computer-readable media storing instructions which, when executed by one or more processors of a computing device, cause the one or more processors to perform operations comprising: determining that a value indicating an operating condition of a battery-powered device exceeds a threshold; determining, based on the value indicating the operating condition and a network priority for the battery-powered device, an operating parameter of the battery-powered device to be changed; and causing the operating parameter to be changed from a first value to a second value.

17. The one or more non-transitory computer-readable media of clause 16, wherein the operations further comprise determining the value indicating the operating condition of the battery-powered device based on at least one of a discrete operating value or state of the battery-powered device, a discrete operating value or state of the battery, or a discrete operating value or state of a peripheral device associated with the battery-powered device.

18. The one or more non-transitory computer-readable media of clause 16 or 17, wherein the operations further comprise determining the network priority of the battery-powered device based on at least one of a recent operating behavior of the battery-powered device, a type of peripheral device associated with the battery-powered device, an account type associated with the battery-powered device, a quantity of network traffic routed through the battery-powered device, or a state of the peripheral device.

19. The one or more non-transitory computer-readable media of any of clauses 16-18, wherein determining the operating parameter of the battery-powered device to be changed comprises determining one or more operating parameters of the battery-powered device that are eligible to be changed, wherein the one or more operating parameters of the battery-powered device that are eligible to be changed are determined based on at least one of the network priority of the battery-powered device or the value indicating the operating condition of the battery-powered device.

20. The one or more non-transitory computer-readable media of any of clauses 16-19, wherein determining the value indicating the operating parameter of the battery-powered device to be changed comprises determining one or more communication parameters of the battery-powered device that are eligible to be changed, wherein the one or more communication parameters of the battery-powered device that are eligible to be changed include at least one of an extended discontinuous reception (eDRX) value, a paging window duration, a data push schedule, a wireless operating mode, or a number of new device beacon transmissions that are to be skipped.

Any and all combinations of any of the claim elements recited in any of the claims and/or any elements described in this application, in any fashion, fall within the contemplated scope of the present protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable media having computer readable program code embodied thereon.

Any combination of one or more computer readable media can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow. Moreover, in the above description, numerous specific details are set forth to provide a more thorough understanding of the various embodiments. However, it will be apparent to one skilled in the art that the inventive concepts may be practiced without one or more of these specific details.

What is claimed is:

1. A method comprising:
determining, by a computing device, that an operating condition of a battery-powered device has been met;
determining, by the computing device and based on the operating condition and a network priority for the battery-powered device, an operating parameter of the battery-powered device to be changed; and
causing, by the computing device, the operating parameter to be changed from a first value to a second value.

2. The method of claim 1, wherein the operating condition of the battery-powered device is determined based on one or more of a current state of the battery-powered device, historical information associated with the battery-powered device, a current state of the battery, historical information associated with the battery, a current behavior of a peripheral device associated with the battery-powered device, or a specified time interval.

3. The method of claim 2, wherein the historical information includes at least one of a change over time in radio frequency (RF) signal strength of the battery-powered device, a frequency of transmissions by the battery-powered device, a historical power consumption of the battery-powered device, or information indicating historical behavior of the peripheral device associated with the battery-powered device.

4. The method of claim 1, wherein the operating condition varies over an operational lifespan of the computing device.

5. The method of claim 1, wherein the operating condition is determined for a specified time interval.

6. The method of claim 1, further comprising determining, by the computing device, the operating condition of the battery-powered device based on at least one of a discrete operating value or state of the battery-powered device, a discrete operating value or state of the battery, or a discrete operating value or state of a peripheral device associated with the battery-powered device.

7. The method of claim 1, further comprising determining, by the computing device, the network priority of the battery-powered device based on at least one of a recent operating behavior of the battery-powered device, a type of peripheral device associated with the battery-powered device, an account type associated with the battery-powered device, a quantity of network traffic routed through the battery-powered device, or a state of the peripheral device.

8. The method of claim 1, wherein determining the operating parameter of the battery-powered device to be changed comprises determining one or more operating parameters of the battery-powered device that are eligible to be changed, wherein the one or more operating parameters of the battery-powered device that are eligible to be changed are determined based on at least one of the network priority of the battery-powered device or the operating condition of the battery-powered device.

9. The method of claim 1, wherein determining the operating parameter of the battery-powered device to be changed comprises determining one or more communication parameters of the battery-powered device that are eligible to be changed, wherein the one or more communication parameters of the battery-powered device that are eligible to be changed include at least one of an extended discontinuous reception (eDRX) value, a paging window duration, a data push schedule, a wireless operating mode, or a number of new device beacon transmissions that are to be skipped.

10. The method of claim 1, further comprising determining, by the computing device, the second value based on a change in power consumption of the battery-powered device associated with the second value.

11. A network device, comprising:
one or more processors; and
a memory storing executable instructions that, when executed by the one or more processors, cause the one or more processors to perform the steps of:
determining that an operating state of a battery-powered device has been met;
determining, based on the operating state and a network priority for the battery-powered device, an operating parameter of the battery-powered device to be updated; and
causing the operating parameter to be updated from a first value to a second value.

12. The network device of claim 11, wherein causing the operating parameter of the battery-powered device to be updated from the first value to the second value comprises transmitting the second value to the battery-powered device from a computing device separate from the battery-powered device.

13. The network device of claim 11, wherein the battery-powered device determines that the operating condition of the battery-powered device has been met and that the operating parameter of the battery-powered device is to be updated.

14. The network device of claim 11, further comprising determining an operational lifespan of the battery is less than an operational lifespan of the battery-powered device, wherein the second value corresponds to a lower power consumption by the battery-powered device.

15. The network device of claim 11, further comprising determining an operational lifespan of the battery is greater than an operational lifespan of the battery-powered device, wherein the second value corresponds to a higher power consumption by the battery-powered device.

16. One or more non-transitory computer-readable media storing instructions which, when executed by one or more processors of a computing device, cause the one or more processors to perform operations comprising:
determining that a value indicating an operating condition of a battery-powered device exceeds a threshold;
determining, based on the value indicating the operating condition and a network priority for the battery-powered device, an operating parameter of the battery-powered device to be changed; and
causing the operating parameter to be changed from a first value to a second value.

17. The one or more non-transitory computer-readable media of claim 16, wherein the operations further comprise determining the value indicating the operating condition of the battery-powered device based on at least one of a discrete operating value or state of the battery-powered device, a discrete operating value or state of the battery, or a discrete operating value or state of a peripheral device associated with the battery-powered device.

18. The one or more non-transitory computer-readable media of claim 16, wherein the operations further comprise determining the network priority of the battery-powered device based on at least one of a recent operating behavior of the battery-powered device, a type of peripheral device associated with the battery-powered device, an account type associated with the battery-powered device, a quantity of network traffic routed through the battery-powered device, or a state of the peripheral device.

19. The one or more non-transitory computer-readable media of claim 16, wherein determining the operating parameter of the battery-powered device to be changed comprises determining one or more operating parameters of the battery-powered device that are eligible to be changed, wherein the one or more operating parameters of the battery-powered device that are eligible to be changed are determined based on at least one of the network priority of the battery-powered device or the value indicating the operating condition of the battery-powered device.

20. The one or more non-transitory computer-readable media of claim 16, wherein determining the value indicating the operating parameter of the battery-powered device to be changed comprises determining one or more communication parameters of the battery-powered device that are eligible to be changed, wherein the one or more communication parameters of the battery-powered device that are eligible to be changed include at least one of an extended discontinuous reception (eDRX) value, a paging window duration, a data push schedule, a wireless operating mode, or a number of new device beacon transmissions that are to be skipped.
